(19) United States
(12) Patent Application Publication
(10) Pub. No.: US 2022/0113979 A1
(43) Pub. Date: Apr. 14, 2022

(54) STORING POST CODES IN ELECTRONIC TAGS

(71) Applicant: Hewlett-Packard Development Company, L.P., Spring, TX (US)

(72) Inventors: Heng-Fu Chang, Taipei City (TW); Chia Hung Kuo, Taipei City (TW); Hung Hua Peng, Taipei City (TW)

(73) Assignee: Hewlett-Packard Development Company, L.P., Spring, TX (US)

(21) Appl. No.: 17/419,492

(22) PCT Filed: Jun. 27, 2019
(86) PCT No.: PCT/US2019/039585

§ 371 Date: Jun. 29, 2021

(51) Int. Cl. G06F 9/4401; G06K 19/07

(52) U.S. Cl. CPC G06F 9/4401; G06K 19/0723

(57) ABSTRACT

The present subject matter relates to techniques for storing POST codes in electronic tags. In an example, a POST code corresponding to each test of a Power ON Self-Test (POST) process may be stored in a Complementary Metal-Oxide Semiconductor (CMOS) chip of a motherboard. The POST code may be indicative of a status of a respective test of the POST process. The POST code corresponding to each test of the POST process is simultaneously stored in a memory of an electronic tag. The electronic tag may be communicatively coupled to the motherboard and the CMOS chip. The POST codes are retrievable from the memory of the electronic tag by an end user of the computing device when the motherboard is powered OFF.

### BACKGROUND

In a computing device, prior to booting up, a Basic Input-Output System (BIOS) of the computing system performs a Power ON Self-Test (POST) process on the computing device. The POST process includes a series of tests and a POST code is generated corresponding to each test during the POST process. The POST code provides a status of a respective test of the POST process. Upon successful completion of the POST process, the computing device initiates a boot process.

### BRIEF DESCRIPTION OF FIGURES

The detailed description is provided with reference to the accompanying figures, wherein:

FIG. 1 illustrates a computing device for storing POST codes in an electronic tag, according to an example;

FIG. 2 illustrates a computing device for storing POST codes in an electronic tag, according to an example;

FIG. 3 illustrates a method for storing POST codes in an electronic tag, according to an example;

FIG. 4 illustrates a method for storing POST codes in an electronic tag, according to an example; and

FIG. 5 illustrates a non-transitory computer readable medium for storing POST codes in an electronic tag, according to an example.

### DETAILED DESCRIPTION

POST codes, generated based on a Power ON Self-Test (POST) process, are stored on a motherboard of a computing device. For example, the POST codes are stored on a Complementary Metal-Oxide Semiconductor (CMOS) chip of the motherboard. In case of any error in the POST process, the POST process may terminate abruptly without enabling the computing device to boot up. In such cases, latest POST codes may be retrieved from the CMOS chip of the computing device. For example, the POST codes may be retrieved by inserting a POST card or by displaying the POST code on a display device. Based on the retrieved POST codes, a developer or service personnel may identify the error and may rectify the error.

As the CMOS chip receives power from the motherboard, in order to retrieve the POST codes from the CMOS chip, the motherboard is to be in a power ON condition. In scenarios where the motherboard does not receive power the motherboard becomes dead or non-functional. As a result, the POST codes may not be retrieved from the CMOS chip and a cause of failure may not be determined.

The present subject matter discloses example approaches for creating a back-up for the POST codes that may be retrieved even when the motherboard is dead, i.e., the motherboard does not receive power. For example, the POST codes may be stored in an electronic tag, such as a Radio Frequency Identification (RFID) tag. The POST codes may later be wirelessly read by an electronic reader.

The present disclosure describes examples of methods and computing devices for storing the POST codes in electronic tags. Prior to booting up the computing device, a POST process may be initiated by the processor of the computing device. The POST process may generate POST codes corresponding to each test of the POST process. The POST codes may be stored in a CMOS chip of a motherboard of the computing device. The POST codes indicate a status of a respective test of the POST process.

The computing device may further include an electronic tag to simultaneously store the POST code corresponding to each test of the POST process in a memory thereof. In case the POST process terminates abruptly, and the motherboard is in a power OFF condition and is therefore dead, the stored POST codes may be retrieved wirelessly from the electronic tag by an end user of the computing device.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

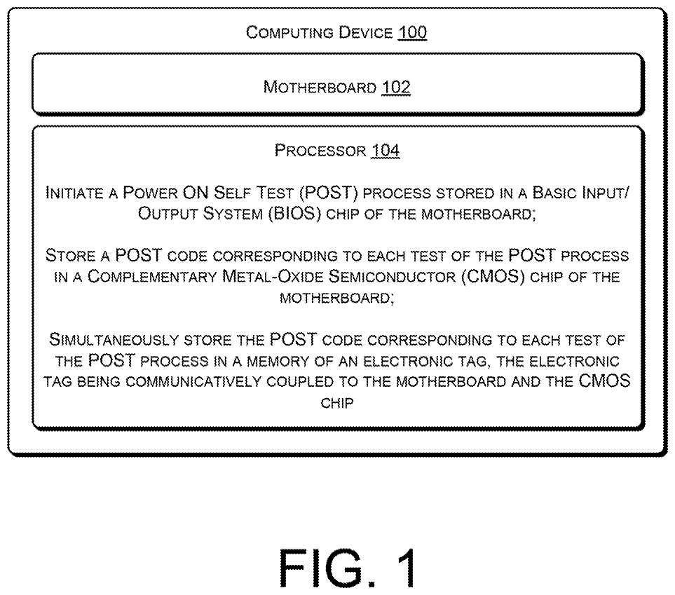

The manner in which the method and system for storing POST codes in electronic tags is implemented are explained in detail with respect to FIGS. 1-5. While aspects of the present subject matter can be implemented in any number of different computing systems, environments, and/or implementations, the examples are described in the context of the following system(s).

FIG. 1 illustrates a computing device 100 for storing POST codes in an electronic tag (not shown). Examples of the computing device 100 may include, but are not limited to, a desktop computer, a personal computer (PC), a tablet PC, a laptop, and so on. The computing device 100 may include a motherboard 102 and a processor 104 communicatively coupled to the motherboard 102. The processor 104 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labelled as “processor(s)”, may be provided through the use of dedicated hardware as well as hardware capable of executing computer-readable instructions.

The processor 104 may initiate a Power ON Self-Test (POST) process stored in a Basic Input/Output System (BIOS) chip (not shown) of the motherboard 102. The term ‘BIOS’ used herein is indicative of a legacy BIOS as well as a Unified Extensible Firmware Interface (UEFI) BIOS. The POST process is a test sequence that is run by the BIOS of the computing device 100 to determine if the fundamental hardware components, such as computer keyboard, random access memory, disk drives, and the like are working correctly or not.

For every test of the POST process, POST codes may be generated by the BIOS chip. A POST code may be indicative of a status of the hardware component for which the test is performed during the POST process. For example, when the computer keyboard is tested under the POST process, a first POST code may be generated indicating commencement of the test for the computer keyboard. Upon successful completion of the test, a second POST code may be generated for the computer keyboard. The second POST code may indicate successful completion of the test and the POST process may proceed to test other hardware components of the computing device 100.

As and when the POST codes are generated, the processor 104 may communicate with the BIOS chip to store the POST codes corresponding to each test of the POST process in a Complementary Metal-Oxide Semiconductor (CMOS) chip (not shown) of the motherboard 102. In an example, the POST codes may be stored in a memory of the CMOS chip. In addition, the processor 104 may simultaneously store the POST codes corresponding to each test in a memory of an electronic tag (not shown). In an example implementation, the electronic tag may be communicatively coupled to the motherboard 102 and the CMOS chip.

In case of failure or powering OFF of the motherboard 102, the stored POST codes may be retrieved from the memory of the electronic tag by an end user of the computing device 100. As the electronic tag is not dependent on the power of the motherboard 102, the electronic tag may remain functional even when the motherboard 102 has become dead.

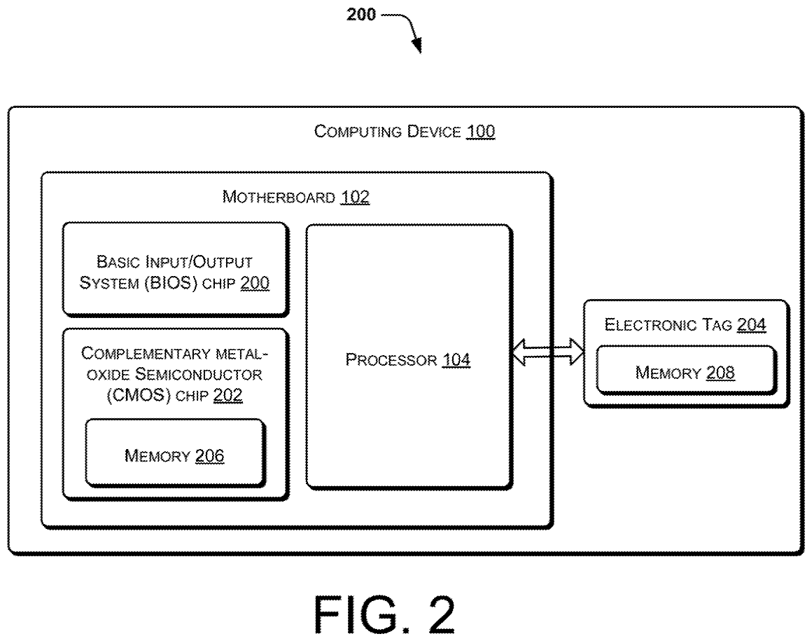

FIG. 2 illustrates a computing device 100 for storing POST codes in an electronic tag, according to an example. The computing device 100 may include the motherboard 102 and the processor 104 communicatively coupled to the motherboard 102. In an example, the motherboard 102 includes a BIOS chip 200 and a CMOS chip 202. The BIOS chip 200 is responsible for initiating the POST process. The CMOS chip 202 stores settings pertaining to the BIOS. Further, the computing device 100 includes an electronic tag 204 communicatively coupled to the motherboard 102. In an example, the electronic tag may be a Radio Frequency Identification (RFID) tag having a non-volatile memory of 8K bits. In an example, to store the POST codes in the electronic tag, the computing device 100 is to be in an S5 power state or soft OFF state. In the S5 power state, the computing device 100 does not perform any computational tasks but trickle current is supplied to a power button of the computing device 100.

The RFID tag may be an active RFID tag or a passive RFID tag. In case of an active RFID tag, the RFID tag may have a transmitter and a separate power supply, such as a battery. On the other hand, the passive RFID tag may not include a battery and may draw power from a reader. Although the electronic tag 204 is described as an RFID tag, the electronic tag 204 may be any other type of electronic tag, such as a Near Field Communication (NFC) tag.

In an example, the electronic tag 204 may be connected to the processor 104 by an Inter-Integrated Circuit (I2C) bus. The I2C bus is a bi-directional two-wire serial bus that provides a communication link between the processor 104 and the electronic tag 204. In another example, the electronic tag 204 may be connected to the processor 104 by a Serial Peripheral Interface (SPI) bus.

In operation, when a power button of the computing device 100 is pressed by an end user, the processor 104 may communicate with the BIOS chip 200 to initiate the POST process. As mentioned earlier, the POST process is a test sequence that is performed on the fundamental hardware components of the computing device 100. During the POST process, a POST code is generated for every hardware component being tested, to indicate a starting and a completion of the test for the hardware component.

The processor 104 may communicate with the BIOS chip 200 to store the POST codes, generated during the POST process for each of the hardware components, in a memory 206 of the CMOS chip 202. The POST codes are maintained in the memory 206 of the CMOS chip 202 by applying constant electric current using a CMOS battery (not shown). As the CMOS battery receives power from the motherboard 102, the CMOS chip 202 is dependent on power supply from the motherboard 102 for storage, maintenance, and extraction of the POST codes.

In an example implementation, to store the POST codes in the electronic tag 204, the processor 104 may communicate with the BIOS chip 200 to also store the POST codes corresponding to each test in a memory 208 of the electronic tag 204. In one example, the processor 104 may simultaneously store the POST codes in the CMOS chip 202 and the electronic tag 204. Accordingly, the processor 104 may send a write command to the electronic tag 204 to write the POST codes in the memory 208 of the electronic tag 204. In an example, the memory 208 of the electronic tag 204 may store data in the form of text strings and thus can be used for storing information other than the POST codes also.

As the POST codes are stored in the memory 208 of the electronic tag 204 during run-time, if the POST process encounters any error or failure, recently stored POST codes may be retrieved from the electronic tag 204. In an example, the POST codes may be retrieved wirelessly by an electronic reader. For example, in case the computing device 100 fails to boot up and the motherboard 102 becomes dead, i.e., does not receive any power, the latest POST codes may be easily extracted from the electronic tag 204 by using an external reader. In an example, the stored POST codes may be retrieved from the electronic tag 204 irrespective of a working condition of the motherboard 102.

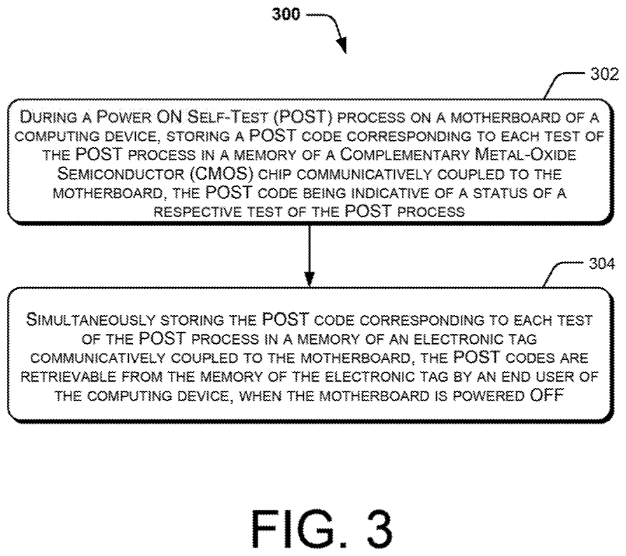

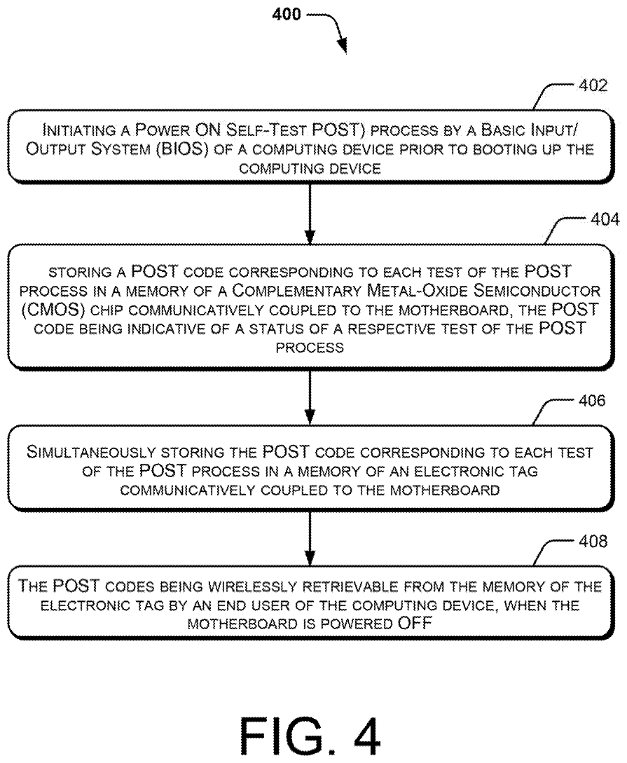

FIGS. 3 and 4 illustrate methods 300 and 400 for storing POST codes in electronic tags, according to examples of the present subject matter. The methods 300 and 400 may be described in the general context of computer executable instructions. The methods 300 and 400 can be implemented by processor(s) or device(s) through any suitable hardware, a non-transitory machine readable medium, or a combination thereof. Further, although the methods 300 and 400 are described in the context of a device that is similar to the computing device 100, other suitable devices or systems may be used for execution of the methods 300 and 400.

The order in which the methods 300 and 400 are described is not intended to be construed as a limitation, and any number of the described method blocks may be combined in any order to implement the methods 300 and 400, or an alternative method. In some example, blocks of the methods 300 and 400 may be executed based on instructions stored in a non-transitory computer-readable medium. The non-transitory computer-readable medium may include, for example, digital memories, magnetic storage media, such as a magnetic disks and magnetic tapes, hard drives, or optically readable digital data storage media.

Referring to FIG. 3, at block 302, a POST code corresponding to each test of a POST process performed in a computing device, such as the computing device 100, may be stored in a memory of a Complementary Metal-Oxide Semiconductor (CMOS) chip communicatively coupled to a motherboard of the computing device 100. The POST code may be indicative of a status of a respective test of the POST process. In an example implementation, the POST codes may be stored by the processor 104 in the CMOS chip 202 of the computing device 100.

At block 304, the POST code corresponding to each test of the POST process may be simultaneously stored in a memory of an electronic tag communicatively coupled to the motherboard. The POST codes are retrievable from the memory of the electronic tag when the motherboard is powered OFF and the POST process terminates abruptly. In an example implementation, the POST codes may be simultaneously stored in the memory of the electronic tag 204 by the processor 104.

Now referring to FIG. 4, at block 402, the method 400 includes initiating a POST process by a Basic Input/Output System (BIOS) of the computing device, such as the computing device 100, prior to booting up the computing device 100. The term ‘BIOS’ used herein may refer to a legacy BIOS as well as a Unified Extensible Firmware Interface (UEFI) BIOS.

At block 404, the method 400 includes storing the POST code corresponding to each test of the POST process in a memory of a Complementary Metal-Oxide Semiconductor (CMOS) chip communicatively coupled to the motherboard.

At block 406, the method 400 includes simultaneously storing the POST code corresponding to each test of the POST process in a memory of an electronic tag communicatively coupled to the motherboard. In an example, the electronic tag is a Radio Frequency Identification (RFID) tag. In an example implementation, the memory of the electronic tag is an 8K bits Non-Volatile Memory (NVM). In an example, to store the POST codes in the electronic tag, the computing device 100 is to be in an S5 power state or soft OFF state. In the S5 power state, the computing device 100 does not perform any computational tasks but trickle current is supplied to a power button of the computing device 100. To wake the computing device 100 from the S5 power state, the computing device 100 is to be rebooted.

At block 408, the POST codes may be wirelessly retrieved from the memory of the electronic tag by an end user of the computing device, for example, when the motherboard is powered OFF. For example, the POST codes stored in the memory of the electronic tag may be wirelessly read through an electronic reader. Thus, a cause of failure of the POST process may be conveniently identified without relying on the motherboard being in a working state.

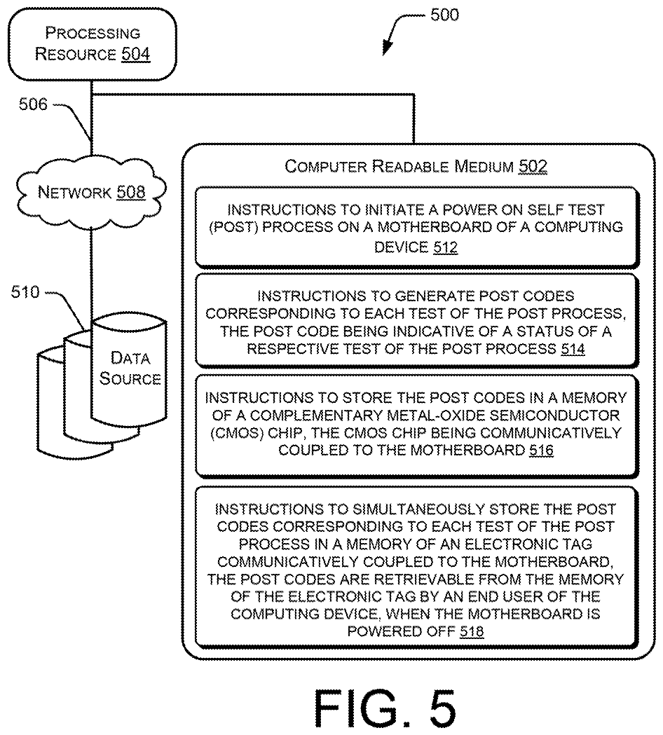

FIG. 5 illustrates an example network environment 500 using a non-transitory computer-readable medium 502 for storing the POST codes in an electronic tag, according to an example of the present subject matter. The network environment 500 may be a public networking environment or a private networking environment. In one example, the network environment 500 includes a processing resource 504 communicatively coupled to the non-transitory computer-readable medium 502 through a communication link 506. For example, the processing resource 504 may be a processor of a computing system, such as the computing device 100, and may be adapted for fetching and executing computer-readable instructions from the non-transitory computer-readable medium 502.

The non-transitory computer-readable medium 502 may be, for example, an internal memory device or an external memory device. In one example, the communication link 506 may be a direct communication link, such as one formed through a memory read/write interface. In another example, the communication link 506 may be an indirect communication link, such as one formed through a network interface. In such a case, the processing resource 504 may access the non-transitory computer-readable medium 502 through a network 508. The network 508 may be a single network or a combination of multiple networks and may use a variety of communication protocols.

The processing resource 504 and the non-transitory computer-readable medium 502 may also be communicatively coupled to data sources 510 over the network 508. The data sources 510 may include, for example, computing device. The data sources 510 may be used by the database administrators and other users to communicate with the processing resource 504.

In one example, the non-transitory computer-readable medium 502 includes a set of computer readable and executable instructions for storing the POST codes in an electronic tag. The set of computer-readable instructions may include instructions as explained in conjunction with FIGS. 1 and 2. The set of computer readable instructions, referred to as instructions hereinafter, may be accessed by the processing resource 504 through the communication link 506 and subsequently executed to perform acts for storing the POST codes in the electronic tag.

Referring to FIG. 5, in an example, the non-transitory computer-readable medium 502 may include instructions 512 to initiate a Power ON Self-Test (POST) process on a motherboard of the computing device 100. In an example, the POST process includes a series of tests to check a status of fundamental hardware components of the computing device 100. Further, the non-transitory computer-readable medium 502 may include instructions 514 to generate POST codes corresponding to each test of the POST process. The POST code may be indicative of a status of a respective test of the POST process. The non-transitory computer-readable medium 502 may also include instructions 516 to store the POST codes in a memory of a Complementary Metal-Oxide Semiconductor (CMOS) chip. In an example, the CMOS chip is communicatively coupled to the motherboard.

The non-transitory computer-readable medium 502 may include instructions 518 to simultaneously store the POST codes corresponding to each test of the POST process in a memory of an electronic tag communicatively coupled to the motherboard. In an example implementation, the memory of the electronic tag is an 8K bits Non-Volatile Memory (NVM). In an example, to store the POST codes in the electronic tag, the computing device 100 is to be operated in an S5 power state or soft OFF state. In the S5 power state, the computing device 100 does not perform any computational tasks but trickle current is supplied to a power button of the computing device 100. To wake the computing device 100 from the S5 power state, the computing device 100 is to be rebooted.

The POST codes may be retrieved later from the memory of the electronic tag by an end user of the computing device 100, for example, when the motherboard 102 is powered OFF. For example, the electronic tag wirelessly communicates with an electronic reader to retrieve the POST codes from the memory of the electronic tag.

Although aspects for the present disclosure have been described in a language specific to structural features and/or methods, it is to be understood that the appended claims are not limited to the specific features or methods described herein. Rather, the specific features and methods are disclosed as examples of the present disclosure.

We claim:

1. A method comprising:
during a Power ON Self-Test (POST) process on a motherboard of a computing device, storing POST codes corresponding to each test of the POST process in a memory of a Complementary Metal-Oxide Semiconductor (CMOS) chip communicatively coupled to the motherboard, the POST codes being indicative of a status of a respective test of the POST process; and
simultaneously storing the POST code corresponding to each test of the POST process in a memory of an electronic tag communicatively coupled to the motherboard,
wherein the POST codes are retrievable from the memory of the electronic tag by an end user of the computing device when the motherboard is powered OFF.

2. The method as claimed in claim 1, further comprising initiating the POST process by a Basic Input/Output System (BIOS) of the computing device prior to booting up the computing device.

3. The method as claimed in claim 1, wherein retrieving the POST codes comprises wirelessly reading the POST codes from the memory of the electronic tag through an electronic reader.

4. The method as claimed in claim 1, wherein the electronic tag is a Radio Frequency Identification (RFID) tag.

5. The method as claimed in claim 1, further comprising causing the computing device to be in an S5 power state for storing the POST codes in the electronic tag.

6. The method as claimed in claim 1, wherein the memory of the electronic tag is an 8K bits Non-Volatile Memory.

7. A computing device comprising:
a motherboard; and
a processor communicatively coupled to the motherboard, wherein the processor is to:
initiate a Power ON Self-Test (POST) process stored in a Basic Input/Output System (BIOS) chip of the motherboard;
store POST codes corresponding to each test of the POST process in a Complementary Metal-Oxide Semiconductor (CMOS) chip of the motherboard, each POST code being indicative of a status of a respective test of the POST process; and
simultaneously store the POST code corresponding to each test of the POST process in a memory of an electronic tag, the electronic tag being communicatively coupled to the motherboard and the CMOS chip,
wherein the POST codes are retrievable from the memory of the electronic tag by an end user of the computing device.

8. The computing device as claimed in claim 7, wherein the POST codes are retrievable if the motherboard is powered OFF.

9. The computing device as claimed in claim 7, wherein the electronic tag is a Radio Frequency Identification (RFID) tag.

10. The computing device as claimed in claim 7, wherein the stored POST codes are retrieved wirelessly through an electronic reader.

11. The computing device as claimed in claim 7, wherein to store the POST codes in the memory of the electronic tag, the processor is to cause the computing device to be in an S5 power state.

12. A non-transitory computer-readable medium comprising computer-readable instructions, which, when executed by a processor of a computing device, cause the processor to:
initiate a Power ON Self-Test (POST) process on a motherboard of the computing device;
generate POST codes corresponding to each test of the POST process, the POST code being indicative of a status of a respective test of the POST process;
store the POST codes in a memory of a Complementary Metal-Oxide Semiconductor (CMOS) chip, the CMOS chip being communicatively coupled to the motherboard; and
simultaneously store the POST codes corresponding to each test of the POST process in a memory of an electronic tag communicatively coupled to the motherboard,
wherein the POST codes are retrievable from the memory of the electronic tag by an end user of the computing device when the motherboard is powered OFF.

13. The non-transitory computer-readable medium as claimed in claim 12, wherein to store the POST codes in the electronic tag, the instructions cause the processor to cause the computing device to be in an S5 power state.

14. The non-transitory computer-readable medium as claimed in claim 12, wherein to retrieve the POST codes, the instructions cause the processor to wirelessly communicate with an electronic reader.

15. The non-transitory computer-readable medium as claimed in claim 12, wherein the memory of the electronic tag is an 8K bits Non-Volatile Memory.
